(19) United States
(12) Patent Application Publication
(10) Pub. No.: US 2012/0106321 A1
(43) Pub. Date: May 3, 2012

(54) METHOD AND DEVICE FOR CONVEYING TRAFFIC IN A NETWORK

(75) Inventors: Zehavit Alon, Raanana (IL); Nurit Sprecher, Petach Tikva (IL)

(73) Assignee: NOKIA SIEMENS NETWORKS OY, ESPOO (FI)

(21) Appl. No.: 13/383,250

(22) PCT Filed: Jul. 10, 2009
(86) PCT No.: PCT/EP2009/058811

§ 371 Date: Jan. 10, 2012

(51) Int. Cl. H04L 12/26; H04L 12/24

(52) U.S. Cl. 370/221; 370/216; 370/228

(57) ABSTRACT

A method and a device convey traffic in a network. The network contains at least one intermediate network element. A master node is connected via the at least one intermediate network element to a first slave node. A deputy node is connected via the at least one intermediate network element to the first slave node. Traffic is conveyed between the master node and the first slave node. In the case of a fault condition the traffic is conveyed between the deputy node and the first slave node. Furthermore, a communication system ideally contains such a device.

The invention relates to a method and to a device for conveying traffic in a network. Also a communication system comprising such device is suggested.

Interconnected packet networks may comprise a customer network and a service provider network. An end-to-end service connection can span several such interconnected packet networks.

Each network can deploy a different packet transport technology for delivering Carrier Ethernet services. Interfaces used to interconnect the networks can be based on IEEE 802.3 MAC and packets that are transmitted over the interfaces can be Ethernet frames (according to IEEE 802.3/802.1). Ethernet frames may be transported via various transport technologies, for example, via ETH (Ethernet), GFP (Generic Framing Procedure), WDM (Wavelength Division Multiplexing), or via ETH/ETY (Ethernet Physical Layer).

Reliability in terms of quality and availability, is a key feature of a Carrier Ethernet service. Service guarantees provided as Service Level Agreements (SLAs) require a resilient network that rapidly detects a failure or a degradation of any facility (interface or node), and restores network operation in accordance with the terms of the SLA. Network survivability is important for delivering reliable services.

The problem to be solved is to efficiently protect at least one service, e.g., Carrier Ethernet services, from a single point of failure, or from a single point of facility (node or interface) degradation, in particular along the path over which the at least one service is delivered in an Ethernet protection domain.

This problem is solved according to the features of the independent claims. Further embodiments result from the depending claims.

In order to overcome this problem, a method for conveying traffic in a network is suggested,
wherein the network comprises at least one intermediate network element;
wherein a master node is connected via the at least one intermediate network element to a first slave node;
wherein a deputy node is connected via the at least one intermediate network element to the first slave node,
wherein traffic is conveyed between the master node and the first slave node;

wherein in case of a fault condition the traffic is conveyed between the deputy node and the first slave node.

It is noted that the master node and the deputy node may be connected via different paths comprising at least partially different intermediate network elements to the first slave node.

It is also noted that any node referred to herein may be a network element or network component. Furthermore, the master node, the deputy node and the first slave node may be edge nodes deployed at the border of the network and may be utilized to be connected to another network, e.g., an access network.

The deputy node may be a redundant node or a protection node than can replace the master node if necessary. There are various scenarios of such replacement, e.g., failure of the master node, failure of a port of the master node, failure of the link (e.g., between the master node and the slave node). It is noted that a failure may be any failure across the network along the path from the master node to the slave node. Hence, any intermediate network element, any intermediate link or any port along the path may cause such failure. The same applies for a degradation along such path. Also, a degradation can be monitored and upon reaching a predetermined threshold, the deputy may take over for the master node. This efficiently allows determining a failure before it actually occurs, e.g., by detecting an increasing delay or the like.

The deputy node may be informed by the slave node or by the master node about the fault condition which triggers the switch-over from the master node to the deputy node. Such switch-over, however, may also be initiated by the deputy node itself when determining a fault condition.

This scenario may correspond to the “1×2 attached” type, i.e. the deputy node and the master node being connected to the first slave node. In case of a fault condition at the master node or at the link between the master node and the slave node, the deputy node takes over or at least temporarily replaces the master node. It is noted that the master node and the slave node are connected via at least one intermediate network element of the network, in particular via several such intermediate network elements.

It is noted that the interface of a node is also referred to as port.

The problem is also solved by a method for conveying traffic in a network;
wherein the network comprises at least one intermediate network element;
wherein a master node is connected via the at least one intermediate network element to a first slave node and to a second slave node;
wherein a deputy node is connected via the at least one intermediate network element to the first slave node and to the second slave node;
wherein traffic is conveyed between the master node and the first slave node;
wherein in case of a fault condition
   the traffic is conveyed between the master node and the second slave node; or
   the traffic is conveyed between the deputy node and the first slave node or between the deputy node and the second slave node.

Hence, upon detection of the fault condition, the deputy node may at least temporarily replace the master node. In particular, dependent on the actual fault condition, the traffic can be conveyed via the other interface of the master node or the master node's functionality may be switched over to the deputy node. The deputy node will in particular replace the master node, if the master node is defect.

It is noted that the nodes mentioned may be any network element within or associated with the network. The network may be a core network connecting, e.g., several access networks. The approach suggested allows protection switching across the network, in particular via several of its intermediate network elements that may be utilized to provide different paths between the master node and the slave node(s) as well as between the deputy node and the slave node(s).

It is noted that also more than two slave nodes can be utilized.

Advantageously, the solution provided complies with reliability requirements for Carrier Ethernet services and is in particular capable of rapidly detecting a failure or facility (node or interface) degradation, e.g., in an Ethernet protection domain. In addition, the solution is capable of restoring traffic without any perceivable or significant disruption of the services provided to the end user. Furthermore, the solution may also efficiently avoid a potential failure or degradation of any node or link.

It is also an advantage that the concept suggested allows for load sharing of traffic between the nodes. Hence, in case of normal operation (without any fault condition), the traffic can be transmitted via separate VLANs, wherein each VLAN may utilize only one connection between the master node and the slave node. Hence, depending on the role (master, deputy, slave) the nodes are assigned to each VLAN, the traffic can be efficiently load shared via different connections (for the “1×2 Attached” scenario as well as for the “2×2 Attached” scenario).

In an embodiment, the master node and the deputy node each comprise two interfaces, wherein each interface is connected to one slave node.

The interfaces are connected via at least one (in particular via several) intermediate network elements of the network to the slave node(s).

Advantageously, the interfaces can be utilized for conveying traffic to the slave nodes. Hence, also the interface conveying the traffic during normal operation can be protected by the other interface; for example, if the current interface cannot reach its destination, the master node (also the deputy node) may switch to the other interface for conveying the traffic via a different path through the network.

In another embodiment, the master node is connected via different paths to the slave nodes. It is also an option that the deputy node is connected via different paths to the slave nodes. In particular, the master node and the slave node utilize different paths throughout the network to be connected to the slave nodes.

In a further embodiment, each path leads via intermediate network elements of the network.

In particular, said paths may be different and thus may utilize (at least partially) different intermediate network elements of the network or a different order of such intermediate network elements.

In a next embodiment,
the master node is connected via a first interface via the at least one intermediate network element to the first slave node and via a second interface via the at least one intermediate network element to the second slave node;
the deputy node is connected via a first interface via the at least one intermediate network element to the first slave node and via a second interface via the at least one intermediate network element to the second slave node; and
in case of the fault condition, the master node or the deputy node switches over from its first interface to its second interface.

Thus, the interfaces of the master node and the deputy node may provide protection for one another, i.e. if one interface fails or a link towards its destination is broken, the respective other interface may be activated. Hence, in normal operation, one path is active and in case of a fault condition, the respective other path may be chosen. As an alternative or if there is no such other path available, the deputy node may be activated and take over the role of the master node. It is noted that the deputy node (in case of any link failure) may also utilize its other interface and thus a different path through the network (even if the master node is still inactive).

It is also an embodiment that after the fault condition is over, the traffic is again conveyed between the master node and the first slave node.

Hence, a switch-over from the deputy node to the master node may be done after the fault condition that led to the switchover from the master node to the deputy node is solved. This is referred to as revertive mode.

However, such revertive mode is an option and it may also be a solution to not reactivate the master node and maintain the operation via the deputy node (this scenario is referred to as non-revertive mode).

Hence, the traffic stream may be maintained even in case the fault condition is over. It is also an option, that the master node and the deputy switch roles, e.g., the deputy node may become the master node after the deputy node has been activated.

Pursuant to another embodiment, the master node, the deputy node and each slave node are network elements at the edge of the network.

The network elements at the edge of the network may preferably utilize a protocol to exchange messages between one another that allow conveying status information between the master node, the deputy node and the at least one slave node.

Deployed at the edge of the network, the master node, the deputy node and the at least one slave node may be connected to an access network.

It is noted that the network referred to herein may be a provider network or a combination of provider networks. The network may in particular span several networks, wherein the nodes (master, deputy, slave) are deployed at the edge of such network.

According to an embodiment, the fault condition comprises or is based on any failure or degradation of an interface or node of the network and in particular comprises at least one of the following:
a link failure,
an interface failure,
a remote interface failure,
a remote node failure,
an administrative operation.
a node, a link and/or a port along a path between the deputy node or the master node and a slave node.

The fault condition may be determined by the master node, by the deputy node or by a slave node. The fault condition may directly or indirectly trigger protection switching, e.g., activating a redundant interface at the master node or at the deputy node or switching-over from the master node to the deputy node. The fault condition determined may be conveyed, e.g., by the slave node to the master node or to the deputy node. The master node or the deputy node may by itself determine a fault condition and trigger protection switching.

According to another embodiment, traffic is conveyed via a virtual local area network (VLAN).

Hence, the traffic conveyed between the nodes mentioned is associated with a VLAN. The physical structure and its connections can be utilized by different VLANs, wherein each edge node (master node, deputy node or slave node) may be assigned a different role per each VLAN. This allows for an efficient load sharing of traffic to be conveyed through the network, as different VLANs may use different edge nodes for different purposes. Also, protection switching is enabled for such VLANs in case of a failure condition.

In yet another embodiment, each portion of traffic is conveyed via a separate virtual local area network.

According to a next embodiment, said traffic is an Ethernet traffic in particular comprising Ethernet frames.

The solution provided, however, can be used by other protocols that have tags or labels to identify a specific (portion of) traffic, e.g., MPLS, MPLS-TP, ATM or Frame Relay (FR).

Pursuant to yet another embodiment, the fault condition is determined by the master node, by the deputy node or by a slave node.

Such fault condition determined may trigger an information to be provided, e.g., to the master node or to the deputy node. The master node may thus switch to the deputy node or the deputy node may activate itself. As an option, the deputy node may deactivate the master node.

The fault condition may relate to a port, to a node or to both. Hence, the master node when determining a fault condition at one of its active ports may switch to an inactive port, activate this port and thus convey the traffic via this newly activated port.

This scenario applies for the deputy node as well. Once the deputy node is being activated (either by a message from a slave node, by a message from the master node or by itself recognizing that the master node is inactive), the deputy node may utilize its ports as described for the master node and thus may provide protection switching between its ports if necessary.

The problem stated above is also solved by a device comprising and/or being associated with a processor unit and/or a hard-wired circuit and/or a logic device that is arranged such that the method as described herein is executable thereon.

According to an embodiment, the device is a communication device, in particular a or being associated with a network element associated with the network or an edge node of the network.

The problem stated supra is further solved by a communication system comprising the device as described herein.

Embodiments of the invention are in particular schematically shown and illustrated in view of the following figures:

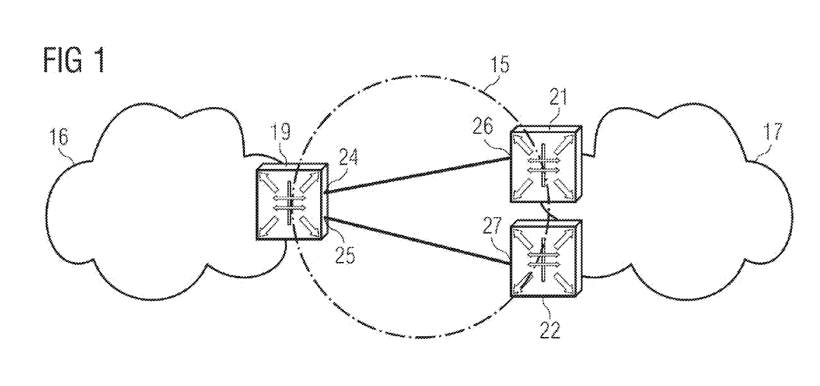

FIG. 1 shows an interconnected zone according to a “1×2 Attached” scenario;

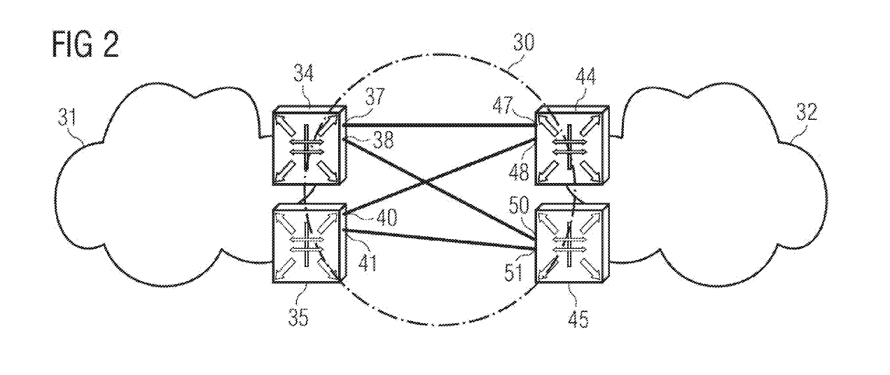

FIG. 2 shows an interconnected zone according to a “2×2 Attached” scenario;

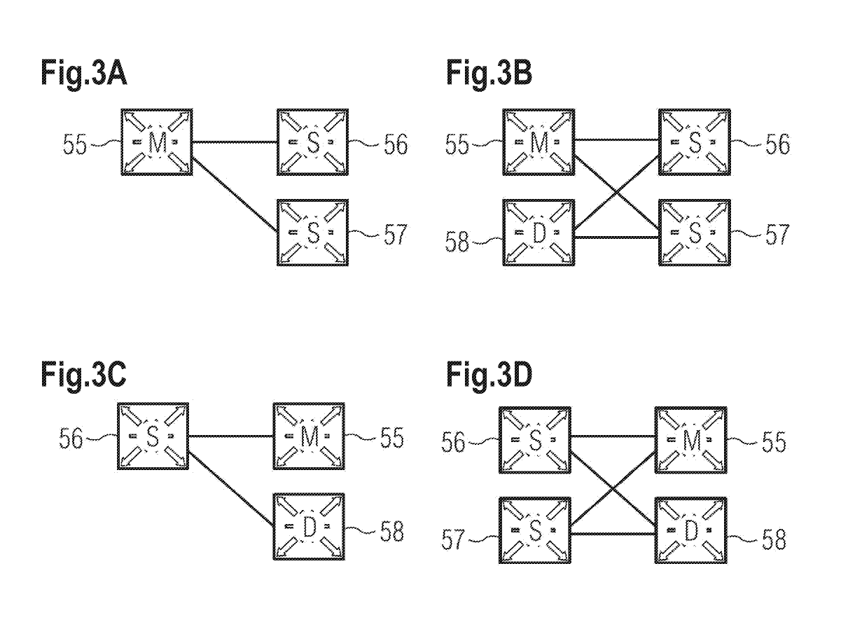

FIG. 3 shows different roles (master, deputy, slave) associated with the scenarios indicated in FIG. 1 and FIG. 2;

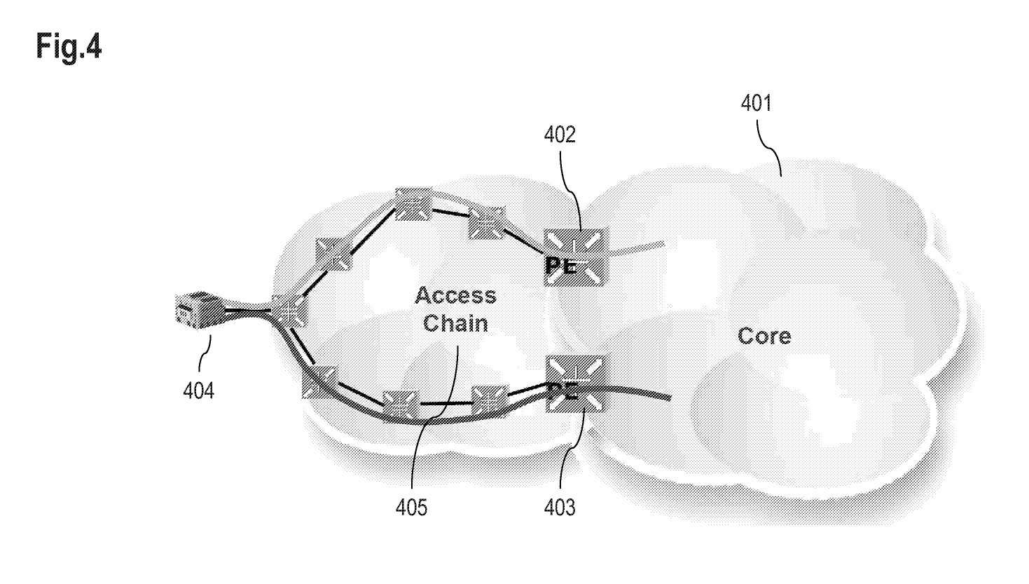

FIG. 4 shows an access chain scenario connecting a core network with a network node;

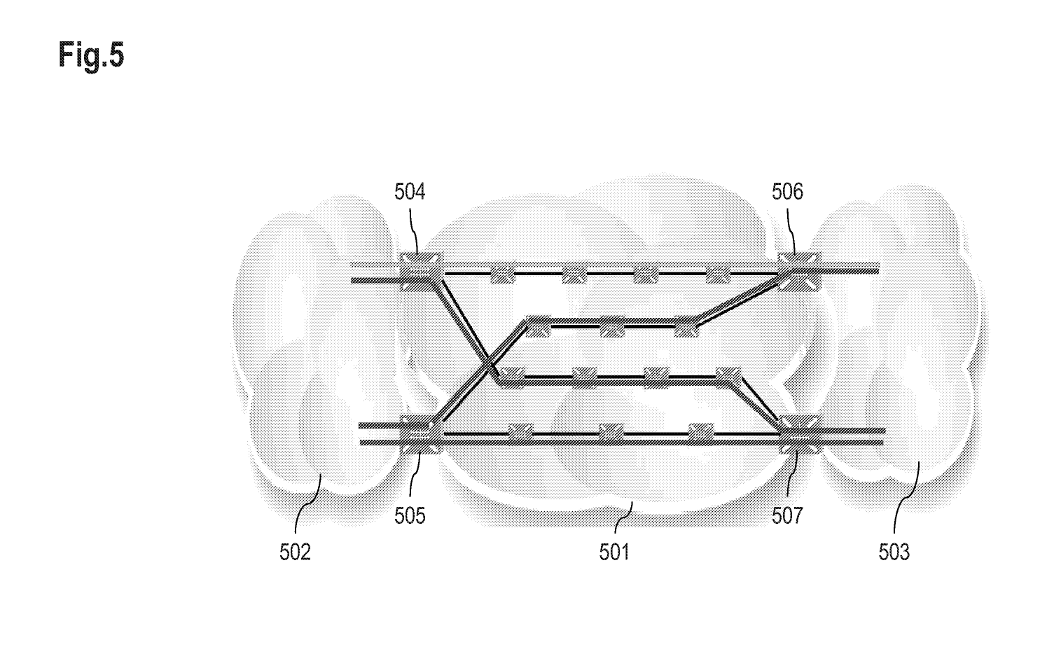

FIG. 5 shows another example for providing protection of Carrier Ethernet services within an Ethernet core network, wherein a core network comprises edge nodes that are connected with one another via several intermediate nodes of the core network;

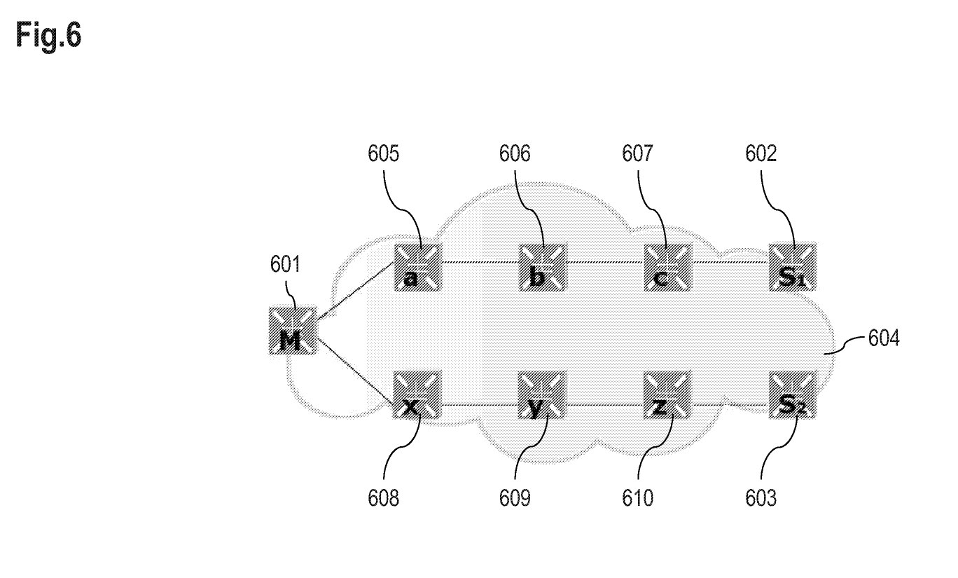

FIG. 6 depicts a “1×2 Attached” scenario applied to a network, wherein edge nodes for protection and load sharing are deployed at the border of the network;

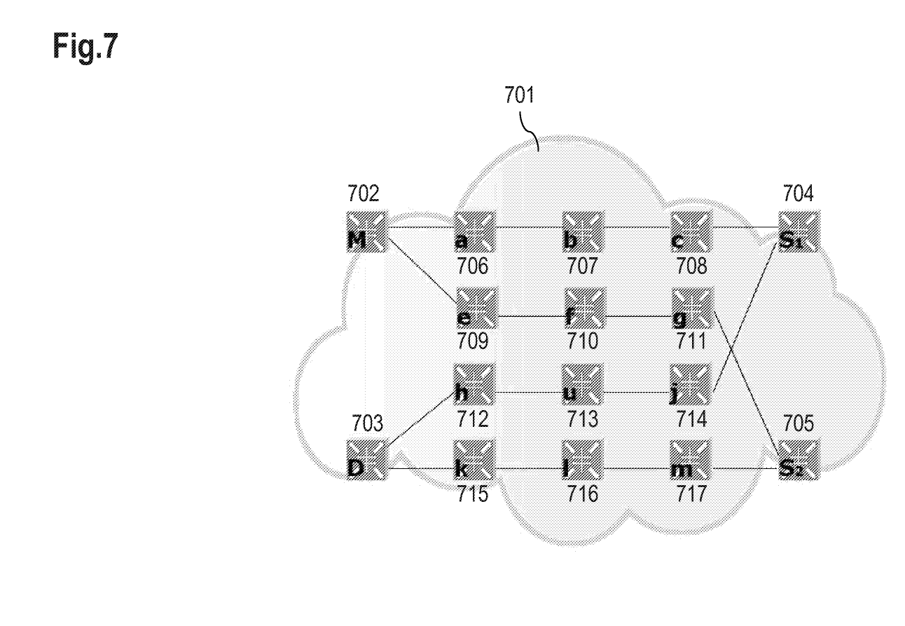

FIG. 7 depicts a “2×2 Attached” scenario applied to a network, wherein edge nodes for protection and load sharing are deployed at the border of the network;

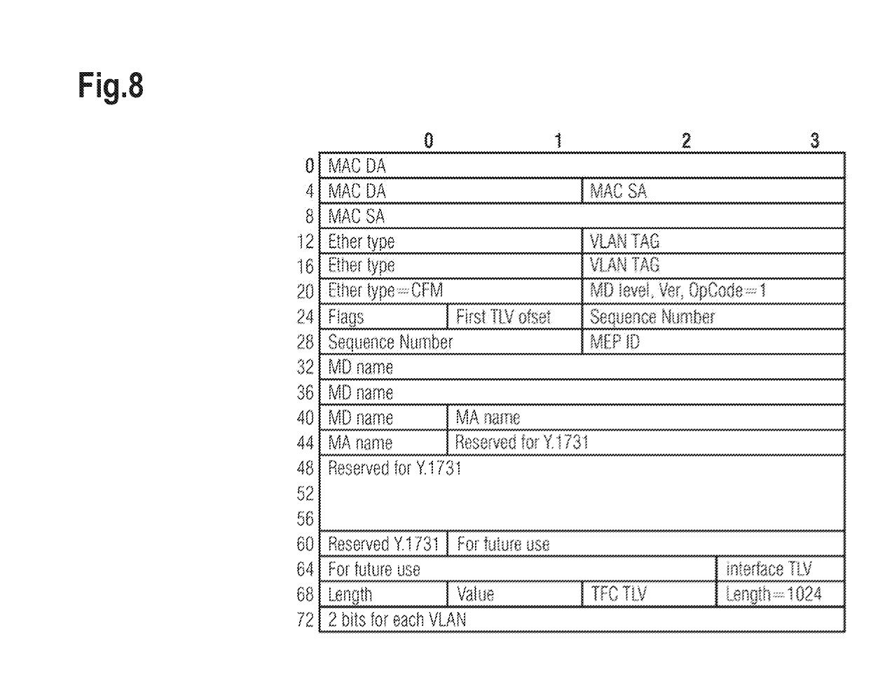

FIG. 8 shows a proposed structure for a TFC TLV based on IEEE 802.1ag CCM;

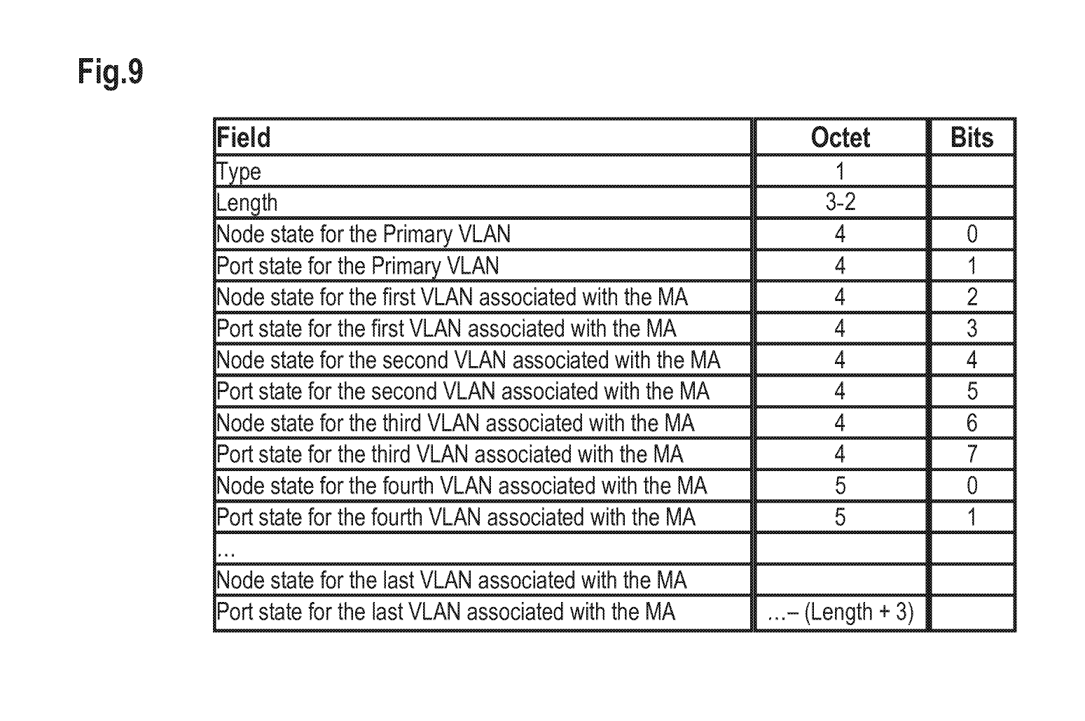

FIG. 9 illustrates an exemplary TFC TLV format;

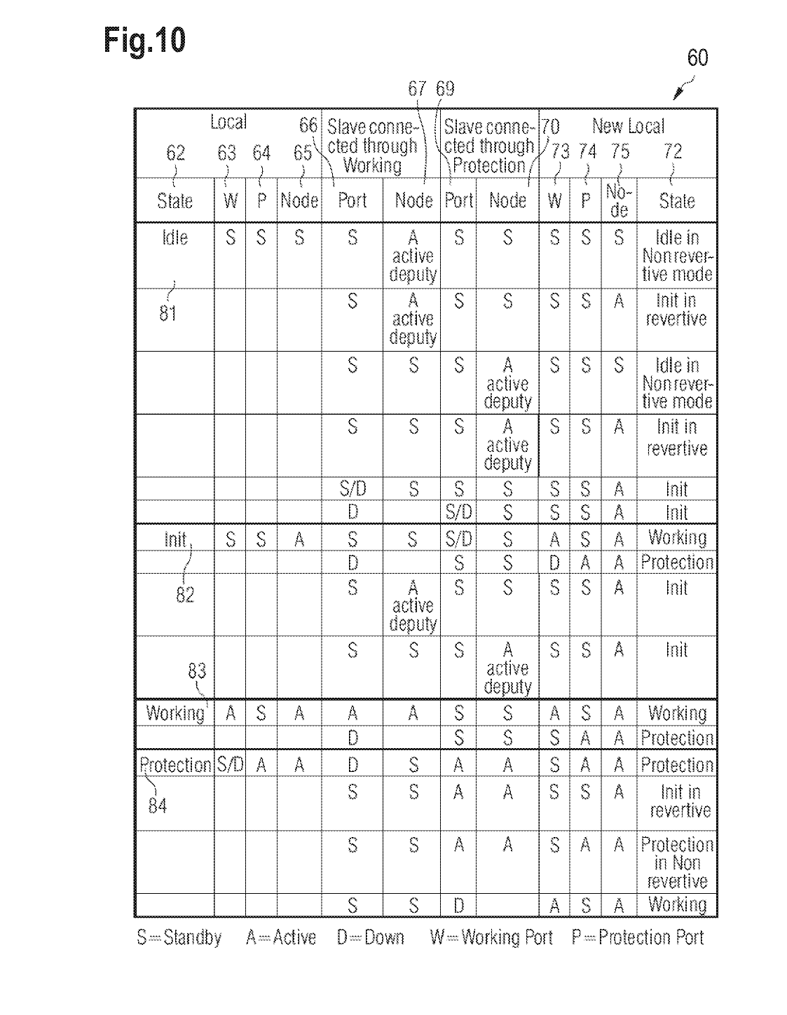

FIG. 10 shows an example of a table summarizing a state machine for the master node;

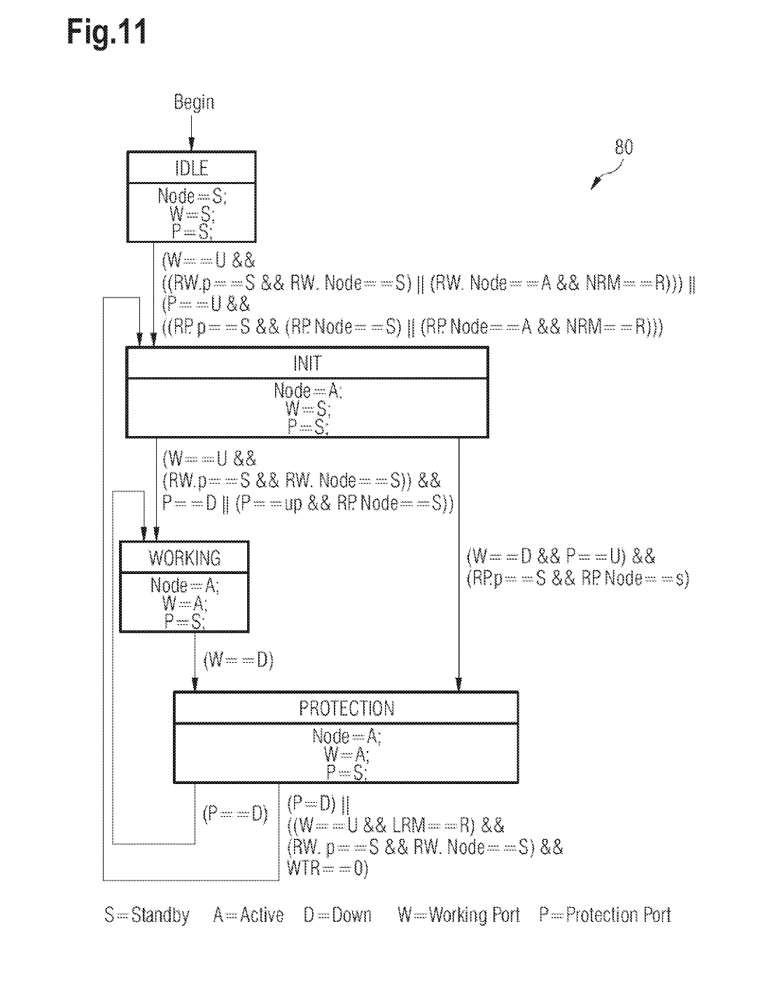

FIG. 11 shows a state diagram of the master state machine of FIG. 10;

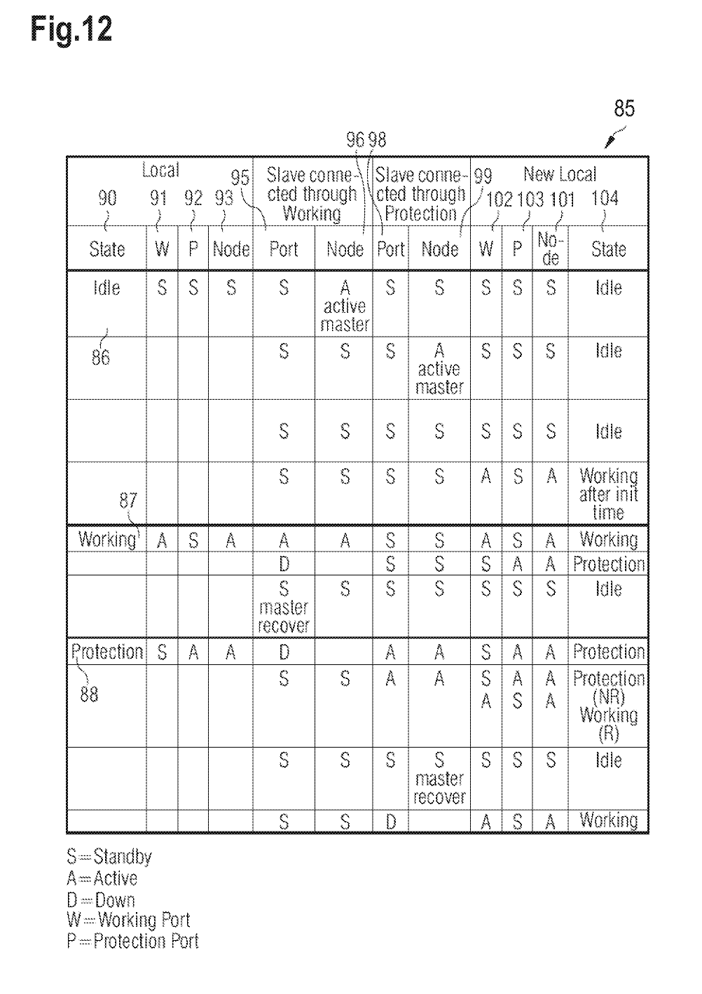

FIG. 12 shows an example of a table summarizing a state machine for the deputy node;

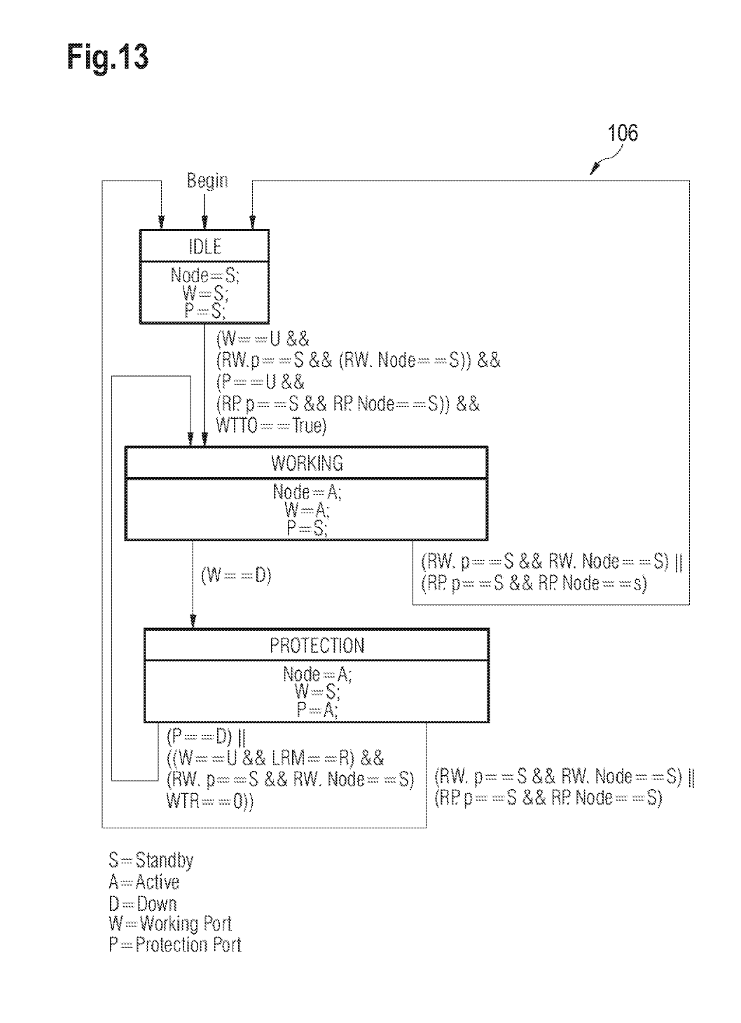

FIG. 13 shows a state diagram of the deputy state machine of FIG. 12;

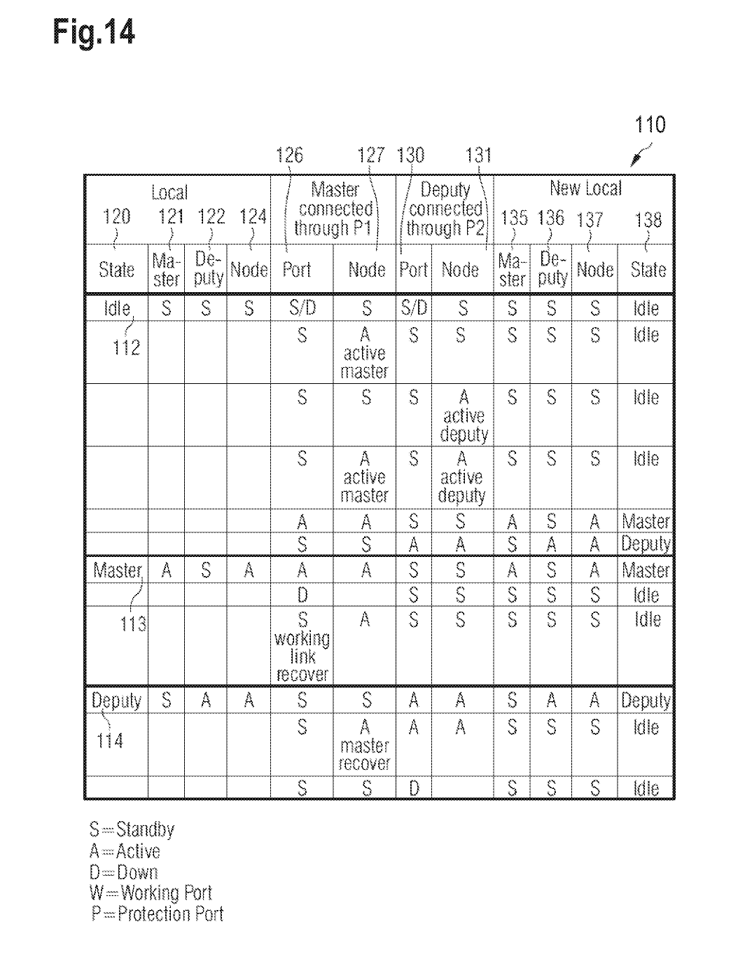

FIG. 14 shows an example of a table summarizing a state machine for the slave node;

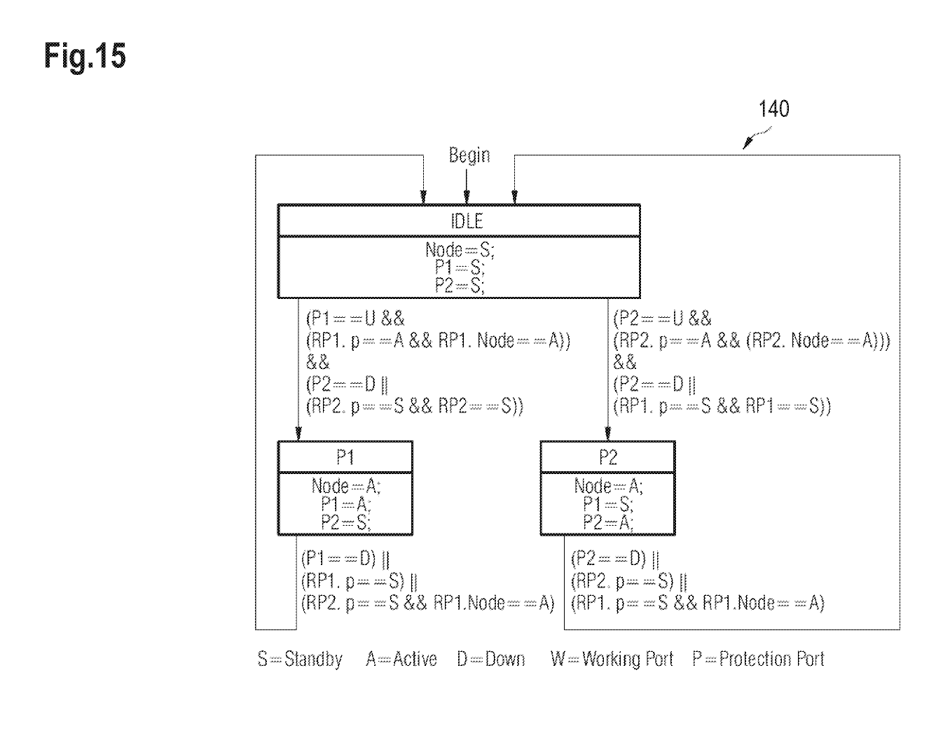

FIG. 15 shows a state diagram of the slave state machine of FIG. 14.

An interconnected zone may be identified between packet networks. Such interconnected zone may comprise nodes and interfaces that act as interconnections between attached packet networks.

The solution described herein can be used protecting Ethernet traffic flows in an interconnected zone of, e.g., a “2×2 Attached” or a “1×2 Attached” scenario.

The protected traffic may be any type of Carrier Ethernet service, e.g., E-Line (Ethernet Line), E-LAN (Ethernet LAN), and E-Tree (Ethernet Tree).

The protected Ethernet traffic may utilize any MEF (Metro Ethernet Forum) service, such as EPL (Ethernet Private Line), EVPL (Ethernet Virtual Private Line), EP-LAN (Ethernet Private LAN), EVP-LAN (Ethernet Virtual Private LAN), EP-Tree (Ethernet Private Tree), or EVP-Tree (Ethernet Virtual Private Tree).

The Ethernet frames used for conveying Ethernet traffic over interfaces in the interconnected zone may be based on or as defined in IEEE 802.1D, IEEE 802.1Q, IEEE 802.1ad or IEEE 802.1ah.

A traffic flow may be conveyed via one of the interfaces which connects the two adjacent networks. In the event of a fault condition at an interface, traffic can be redirected to the redundant interface. In a “2×2 Attached” interconnected zone, if a node is no longer able to convey traffic (e.g., due to a fault condition of the node), traffic can be redirected to a redundant node.

It is noted that a fault condition may be or result from any failure or degradation of an interface or node, comprising in particular at least one of the following:
a link failure,
an interface failure,
a remote interface failure,
a remote node failure,
an administrative operation.

It is noted that the interface of a node is also referred to as port.

The protected Ethernet traffic can be tagged or untagged. In case of tagged Ethernet traffic, protection can be provided via a VLAN (Virtual Local Area Network), wherein each VLAN could be processed separately from any other VLAN. It is noted that this solution may apply to an outer VLAN of a frame.

Traffic from various VLANs can be transmitted over different interfaces connecting the two adjacent networks. The (outer) VLAN can be of any of the following tags: a C-VLAN (customer VLAN), an S-VLAN (Service VLAN) or a B-VLAN (backbone VLAN).

In IEEE 802.1Q, IEEE 802.ad and IEEE 802.1ah switches, untagged traffic is tagged by a port VLAN identifier, which results in tagged traffic. In IEEE 802.1D switches, protection can be implemented on the entire traffic that is transmitted over the interface.

The mechanism described herein can be used by any type of traffic (e.g., Ethernet traffic), in particular by any type of traffic that can be identified by a tag, a label or the like. Examples are: MPLS, MPLS-TP, ATM or FR.

FIG. 1 shows an exemplary embodiment of an “1×2 Attached” interconnected zone 15, which is also referred to as “dually-attached” interconnected zone. The interconnected zone 15 connects a first communication packet network 16 to a second communication packet network 17.

The first communication packet network 16 comprises a node 19, the second communication packet network 17 comprises a node 21 and a node 22.

The node 19 has a two interfaces 24 and 25, the node 21 has an interface 26 and the node 22 has an interface 27.

Within the interconnected zone 15 the interface 24 is connected to the interface 26 and the interface 25 is connected to the interface 27.

The first communication packet network 16 and the second communication packet network 17 may in particular provide Ethernet communication services for their users.

The interconnected zone 15 can be part of several VLANs (not shown in FIG. 1) and may support Ethernet traffic for each VLAN. Also, the interconnected zone 15 may support untagged traffic.

For a specific VLAN, only one of the two interfaces 24, 25 can be used to forward traffic.

The node 19 may forward Ethernet traffic to the node 21 or to the node 22. The Ethernet traffic may convey Ethernet services or Carrier Ethernet services. For a specific VLAN, only the node 21 or the node 22 can be used at any time to forward said Ethernet traffic.

The Ethernet traffic is conveyed via a link from one interface on one side of the interconnected zone 15 to another interface on the other side of the interconnected zone 15. This Ethernet traffic is protected against a fault condition, e.g., a failure or degradation of a link or an interface within the interconnected zone 15.

The link between interfaces 24 and 26 or the link between interfaces 25 and 27 can be used for conveying Ethernet traffic. In case of a fault condition (e.g., failure or degradation), Ethernet traffic may be redirected from on link to the other.

The protection mechanism suggested allows for a rapid detection of failure or degradation within a time period of about 10 ms and ensures a fast recovery time usually within less than 50 ms.

The mechanism also allows for a service provider utilizing resources in the interconnected zone in an efficient way by utilizing load sharing of Ethernet traffic. For example, such load sharing may introduce an overlapping scheme of the protection in order to reduce the total required bandwidth: Hence, one link may be used for one VLAN, the other link of the interconnected zone may be used for another VLAN; the links may thus be efficiently distributed among different VLANs to enable load sharing.

The protection of the Ethernet traffic may not require a connection or a communication channel between the pair of nodes of the same network.

The protected Ethernet traffic can be tagged or untagged. The tagging of Ethernet traffic marks packets of the Ethernet traffic with an internal identifier that can later be used for filtering, identifying or address translation purposes.

Ethernet Traffic from various VLANs can be transmitted via the link connecting of interfaces 24 and 26 or the link connecting interfaces 25 and 27.

FIG. 2 depicts a “2×2 Attached” interconnected zone 30 connecting a network 31 with a network 32.

The communication packet network 31 comprises a node 34 and a node 35. The node 34 comprises two interfaces 37 and 38 and the node 35 comprises two interfaces 40 and 41. The communication packet network 32 comprises a node 44 and a node 45. The node 44 comprises two interfaces 47 and 48 and the node 45 comprises two interfaces 50 and 51.

The interface 37 is connected to the interface 47, the interface 38 is connected to the interface 50, the interface 40 is connected to the interface 48, and the interface 41 is connected to the interface 51.

Each interface is also referred to as port.

The interconnected zone 30 comprises or is associated with said nodes 34, 35, 44, 45 as well as their interfaces mentioned above.

For a specific VLAN, only one of the four interfaces 37, 38, 40, 41 can be used at any time to forward Ethernet traffic.

If a fault condition or failure occurs on at the interface 37 or at the interface 47, Ethernet traffic can be redirected to the other interface 38 of the node 34.

If a fault condition occurs at the node 34, the Ethernet traffic can be redirected to the node 35. In such scenario, the node 35 can be referred to as “redundant node” or “protection node”.

Pursuant to such a node protection event, a notification of a change in network topology can be sent to the network 31. This allows the Ethernet traffic to be directed to the appropriate node (e.g., to the node 35 if node 34 cannot be reached).

There are various possibilities for sending such a notification, e.g., depending on the packet transport technology employed in the network. In case of Ethernet packet technology, an MVRP (Multiple VLAN Registration Protocol) message can be sent to the network causing relevant entries to be updated in an FDBs (Filtering Data Bases) of the network. In case of VPLS (Virtual Private LAN Service), a “MAC Address Withdrawal” message can be sent indicating that a node is (temporarily) inactive.

The interconnected zone 30 thus provides a reliable way of transmission. For a specific VLAN, only one of the four interfaces can be used at any point of time to forward traffic.

As an example, Ethernet traffic may be conveyed via a particular VLAN. The Ethernet traffic of this VLAN is transmitted via the interface 37 and the interface 47. If a fault occurs on the interface 37, the Ethernet traffic can be redirected to the interface 38 of the node 34, wherein the interface 38 is connected to the interface 50 of the node 45.

If the node 34 fails, the Ethernet traffic is redirected via the node 35 instead of the node 34.

The node 34 of the interconnected zone 30 may work as a master node. This master node 34 is responsible for selecting the interface 37 or the interface 38 over which the Ethernet traffic is transmitted. The peer nodes 44 and 45 attached to the network 32 work as slave nodes following the master node's decision. The master node 34 is protected by the node 35, also referred to as deputy node, which is attached to the slave nodes 44 and 45. If the master node 34 fails, the deputy node 35 acts as a substitute for the master node 34.

It is noted that the node referred to herein may be any network device or network element.

All nodes 34, 35, 44 and 45 of FIG. 2 can have multiple roles, dependent on the single VLAN. In other words, each node can be a master node, a slave node or a deputy node dependent on the definition per VLAN, e.g., for one VLAN node 35 may be a master node and for another VLAN this node 35 may be a slave node.

FIG. 3A shows a “1×2 Attached” scenario with an interconnected zone comprising a node 55 acting as master node and being connected to two slave nodes 56, 57 of an attached network.

It is noted that pursuant to such a “1×2 Attached” scenario, it is also possible to have one slave node 56 attached to a master node 55 and a deputy node 58 as shown in FIG. 3C.

FIG. 3B shows a “2×2 Attached” scenario with an interconnected zone comprising the node 55 acting as a master node being connected to the two slave nodes 56, 57 and an node 58 that acts as a deputy node and is attached to the two slave nodes 56, 57.

It is noted that the scenario of FIG. 3B can be mirrored as shown in FIG. 3D.

The role of each node (master, deputy and slave) in an interconnected zone can be set by administrative configuration for each VLAN. Thus, a node may function as a master node in some VLANs and as a deputy node in other VLANs. This allows for an efficient load sharing of traffic between the nodes of the interconnected zone.

The protection mechanism can be performed per VLAN, independent of other VLANs. The approach presented also refers to protection of Ethernet traffic of a specific VLAN. The mechanism works accordingly for each VLAN in the interconnected zone.

A protected VLAN may be configured on one or two ports of each node on the interconnected zone. However, as described above, Ethernet traffic in a specific VLAN may only be transmitted over one of the interfaces in the interconnected zone.

Each of the nodes in an interconnected zone may comprise a forwarding condition per VLAN, indicating whether the node is in an “active” or in a “standby” forwarding condition for the Ethernet traffic in this respective VLAN.

For example, the node forwarding condition of nodes 34 and 44 in FIG. 2 is “active”, while the node forwarding condition of nodes 35 and 45 is “standby”. Moreover, each of the ports (on which that specific VLAN is configured) in an interconnected zone has a forwarding condition relating to that particular VLAN, indicating whether the port is in an “active” or “standby” forwarding condition for Ethernet traffic of that VLAN. For example, the port forwarding condition of ports (interfaces) 37 and 47 in FIG. 2 is “active”, while the port forwarding condition of the other ports (interfaces 38, 48, 40, 41, 50 and 51) is “standby”. If there is a fault condition on the interface between nodes 34 and 44, the forwarding condition of node 44 will change to “standby”, and the forwarding condition of node 45 will change to “active”. In addition, the forwarding condition of ports 38 and 50 will change to “active”, while the condition of the other ports (37, 47, 48, 40, 41 and 51) will be “standby”. Hence, Ethernet traffic received in a VLAN may be forwarded to the attached network only through a node and a port which are in the “active” forwarding condition.

In an interconnected zone, each port may communicate to its peer port in the attached network, i.e. to the port to which it is directly connected, the forwarding condition (per VLAN) of its associated node as well as its own forwarding condition. For example, port 37 sends its node state (i.e. the state of the node 34) and its port state to port 47, port 47 sends its node state (i.e. the state of the node 44) and its port state to port 37; port 38 sends its states to port 50, and so on.

In each of the nodes, a VLAN may be configured for two ports. Only one of these ports may have an “active” forwarding condition for this VLAN. In the master and deputy nodes, one of the ports is configured as a working port for this VLAN, while the other port is configured as a protection port for this VLAN. This configuration defines the port that is preferably assigned the “active” forwarding condition.

In addition, a revertive and a non-revertive mode for that VLAN can be configured. Such revertive mode can be supported on a node level and/or on a port level.

In the revertive mode on the node level, traffic is restored to the master node after the condition(s) that caused the switchover is/are solved. In the non-revertive mode on the node level, traffic remains with the deputy node after the problem that caused the switchover is solved.

In the revertive mode on the port level, traffic is restored to the “working” port after the condition(s) that caused the switchover is/are solved. In the non-revertive mode on the port level, traffic remains on the “protection” port after the condition(s) that caused the switchover is/are solved.

At any point in time, each node in an interconnected zone may decide which of its ports to be used for conveying traffic. This decision can be made based on at least one of the following information:
The role of the node (i.e. master, deputy or slave).
The role of the port in case of a master or a deputy node. This role of the port may be either “working” or “protection”. An additional information is the revertive or the non-revertive mode for the respective VLAN.
The current forwarding condition of the node.
The current forwarding condition of the port.
The forwarding conditions of the peer nodes and ports in the attached network; such forwarding condition may be received over the ports connected to the peer nodes and ports.

When the nodes start up under normal conditions (i.e. without any failure condition in the interconnected zone), the “working” port is selected to forward traffic and its port's forwarding condition is set to “active”. If the port cannot forward traffic due to any reason (e.g., port failure, remote port failure, etc.), the “protection” port is selected to forward traffic and this port's forwarding condition is set to “active”. The traffic switches over to the “protection” port.

Depending on the revertive/non-revertive mode configured for a particular VLAN, the forwarding condition of the “protection” port either changes to “standby” or remains “active” when the problem (e.g., fault condition or failure) that caused the switchover is solved.

If the master node fails and if a deputy node (e.g., in a “2×2 Attached” interconnected zone) exists, the deputy node takes over the master node's role. The deputy node changes its node forwarding condition to “active” and one of the ports of the deputy node changes its forwarding condition to “active”. If the master node fails and if no deputy node (e.g., in a “1×2 Attached” interconnected zone) exists, traffic cannot be forwarded through the interconnected zone until the master node recovers. In this “1×2 Attached” scenario, the master node is a single point of failure.

The slave nodes may adjust themselves according to the decision of the master node. The forwarding condition of a slave node is “active” if that of its peer node (master or deputy) is “active” AND if the forwarding condition of the peer port to which it is directly connected is “active”. In such a scenario, the forwarding condition of the port in the slave node (through which the nodes are connected) is also “active”.

The forwarding condition of the deputy node can be set to “standby” by default. As long as the deputy node learns that one of its peer nodes has an “active” forwarding condition, it may conclude that the master node is up and working properly (hence the deputy node's forwarding function is not required and the deputy node can maintain its standby status). When the deputy node detects that none of its peer nodes is in an “active” forwarding condition, it may conclude that the master node has failed to forward traffic and the deputy node may take over the master node's role by changing its forwarding condition to “active” and by selecting one of its ports to forward the traffic, i.e. setting such port to “active”. The slave nodes may adjust themselves to the decision of the deputy node, which now acts as a substitute for the master node.

The mechanism described herein includes messages that are used to communicate the node and port forwarding conditions between the peer ports. Also, state machines (per VLAN) may be defined that are used to control the forwarding conditions of the nodes and the ports in the interconnected zone.

Each node in an interconnected zone may have a functional entity referred to as a Traffic Forwarding Controller (TFC). The TFC is used to control the forwarding conditions (per VLAN) of the nodes that are connected in an interconnected zone and the ports that connect the nodes to the attached network.

The TFC serves as a logical port that bundles the set of ports in a node which resides in the interconnected zone. It is noted that these bundled ports may not be considered as bridge ports. Instead, the TFC can be perceived as a bridge port according to a IEEE 802.1 bridge relay function, and VLANs can be defined as members of the TFC, as defined on any other bridge port. The TFC may forward traffic to the appropriate underlying port and collect traffic from the underlying ports. Thus, MAC addresses can be learnt by the TFC instead of the underlying ports, which are controlled by the TFC.

The TFC is configured together with the VLANs to be handled and together with the one or two underlying ports that are capable of forwarding this single VLAN. VLAN traffic can be forwarded according to the IEEE 802.1 bridge relay function to the TFC (when it belongs to the member set of that VLAN), which in turn forwards it to the port which is in an “active” forwarding condition. If the TFC does not have a port with an “active” forwarding condition for that VLAN, the packets may be dropped.

The TFC may keep information about each VLAN of which it is a member. This information comprises forwarding conditions of the node and ports for that VLAN. It may happen that the forwarding condition of a node for a particular VLAN is “active”, while it is “standby” for another VLAN.

As indicated above, the role, configuration and/or functionality (or a portion thereof) of the master node may be handed over to the deputy node. The master node can thus obtain information from its peer slave node that indicates that the peer slave node deteriorates or is going to deteriorate, e.g., to slow down.

The slave node may also provide feedback to the master node indicating a defect, a fault condition or failure of the slave node concerning, e.g., a connectivity problem of the slave node with its own network. Such indication provided by the slave node may trigger a switching from the master node to the deputy node. Such switching may also be triggered due to OAM and/or administrative reasons.

It is noted that such trigger may be based on a detection of any physical problem (e.g., a loss of a link) or based on any control protocol indicating a problem.

The deputy node and/or the master node may determine such fault condition or failure, e.g., from a data packet trans-mission degradation derived from checksum errors by applying techniques like CRC (cyclic redundancy check) or FRC (frame check sequence). As an alternative or in addition, a fault condition or failure may also be determined based on a performance monitoring between the master node and the slave node or between the deputy node and the slave node: Hence, a delay, a delay variation or a data packet loss exceeding a certain threshold may indicate a significant degradation or a pending defect of a node or port. Such information can be used to initiate a switch over to a different node or port prior to the actual defect or in order to increase the performance.

Also, the deputy node may decide taking over the role of the master node when it does not receive a status information from the master node after a given period of time. The master node may decide changing traffic flow direction after not having received a status information from its associated slave node after a predetermined period of time. Such predetermined period of time may also include some additional delay to avoid unnecessary switching between the nodes (hysteresis).

The communication between the nodes can be used to exchange information between the master node and the deputy node via the slave node and between the two slave nodes either via the master node or via the deputy node. Such information may include synchronization of the protection status, administrative requests, switch over information, switch back information, synchronization of a configuration, information related to the status of the node's underlying network.

After a direction of the transmission is changed, also the network topology may be adjusted. The affected network can be informed of the changed network topology so that the network knows about the node that is used for communication with the other network.

The nodes of the interconnected zone may provide different functionalities (master, deputy and slave) depending on the particular VLAN. For different VLANs, a particular node may thus be a master node in the first VLAN and a slave node in the second VLAN.

### State Machine

Each of the three types of nodes (master, deputy and slave) may have its own state machine. The state machines may reside in the TFC and could be defined per VLAN. The state machine determines the forwarding state of the (one or two) ports on which the VLAN is defined and the forwarding condition of the node for that VLAN. The forwarding condition may change as a result of events that occur locally in the node, or remotely in the peer nodes, or on the interfaces which connect the peer nodes.

The forwarding conditions of the remote peer and of its ports, resulting from events occurring on the remote peer, can be communicated by messages.

### Master State Machine

FIG. 10 shows an example of a table 60 summarizing a state machine for the master node. The master node is connected to one slave node via its “working” port. The master node can also be connected to another slave node via its “protection” port.

In the “1×2 Attached” scenario, the master node can be connected to one or to two slave nodes and in the “2×2 Attachment” scenario, the master node can be connected to two slave nodes.

A master state machine comprises an Idle state 81, an Init state 82 (also referred to as initial state), a Working state 83, and a Protection state 84.

The Idle state 81 indicates that the TFC is not forwarding Ethernet traffic. The node forwarding condition is “standby”. The port forwarding condition for both the “working” and “protection” ports is “standby”.

In the Init state 82, the node forwarding condition is “active” but the forwarding condition of both “working” and “protection” ports is “standby”. None of the ports forwards Ethernet traffic.

The Init state 82 is a transient state, which may occur in the revertive mode on the node level when a failed master node has recovered and before it resumes Ethernet traffic forwarding. In this state, the deputy node is informed that the master node has recovered and that the master node wishes to forward Ethernet traffic. This state may prevent that two nodes act as master nodes at the same time and that more than one port forward network Ethernet traffic for the same VLAN at the same time.

The Working state 83 indicates that the forwarding conditions for the node and the “working” port are “active”. The “protection” port is in the “standby” forwarding condition.

The Protection state 84 indicates that the node is in an “active” forwarding condition, that the “protection” port is in the “active” forwarding condition and that the “working” port is in the “standby” forwarding condition.

This Protection state 84 is applicable when the “working” port cannot forward Ethernet traffic. This may occur because of a fault condition or it may occur pursuant to a recovery from a fault condition in the non-revertive mode on the port level.

Columns depicted in the table of FIG. 10 indicate a local state 62 of the master node, a forwarding condition 63 of the “working” port, a forwarding condition 64 of the “protection” port, and a forwarding condition 65 of the node itself.

The columns also show port forwarding conditions 66 and node forwarding conditions 67 of a slave node to which the master node is connected via its “working” port. Information regarding forwarding conditions 66 and 67 can be communicated to the “working” port by the slave node.

Similarly, the columns depict port forwarding conditions 69 and node forwarding conditions 70 of a slave node to which the master node is connected via its “protection” port. Information regarding forwarding conditions 69 and 70 can be communicated to the “protection” port by the slave node.

The table of FIG. 10 also depicts a new local state 72, a new forwarding condition 73 of the “working” port, a new forwarding condition 74 of the “protection” port and a new node forwarding condition 75 of the master node.

FIG. 11 depicts an example of a state flow chart 80 of the master state machine.

### Deputy State Machine

FIG. 12 shows an example of a table 85 of a state machine of the deputy node that is connected to the slave nodes via the “working” port and the “protection” port.

The deputy state machine comprises an Idle state 86, a Working state 87 and a Protection state 88. These states are similar to the states of the master state machine described above. The deputy node starts in the Idle state 86.

Columns of the table show a local state 90, a forwarding condition 91 of the “working” port, a forwarding condition 92 of the “protection” port, and a forwarding condition 93 of the node.

The table also shows port forwarding conditions 95 and node forwarding conditions 96 of a slave node to which the deputy node is connected via its “working” port. Information regarding forwarding conditions 95 and 96 can be communicated to the “working” port by the slave node.

Similarly, the columns depict port forwarding conditions 98 and node forwarding conditions 99 of a slave node to which the deputy node is connected via its “protection” port. Information regarding forwarding conditions 98 and 99 can be communicated to the “protection” port by the slave node.

The table of FIG. 12 also depicts a new forwarding condition 101 of the deputy node, a new forwarding condition 102 of the “working” port, a new forwarding condition 103 of the “protection” port, and a new local state 104.

A state flow chart 106 of the deputy state machine is depicted in FIG. 13.

### Slave State Machine

FIG. 14 shows an example of a table 110 that defines a state machine of the slave node that is connected to the master node and (as an option depending on the interconnected zone also) to the deputy node. The interconnected may be defined by the “1×2 Attached” scenario or by the “2×2 Attached” scenario.

The slave state machine comprises an Idle state 112, a Master state 113, and a Deputy state 114. These states 113 and 114 could be perceived as port states, because the slave node may be not aware to which of these ports the master node is connected and to which of these ports the deputy node is connected. Hence, the names chosen for the states 113 and 114 indicate that the respective port may be connected to either the master node or to the deputy node.

In the Idle state 112 the slave node is not forwarding Ethernet traffic. The forwarding conditions of the slave node is on standby; also, its (one or two) port(s) is/are on “standby”.

The Master state 113 shows that the slave node is connected to the master node and thus active, i.e. the slave node itself is in “active” state and the forwarding condition of its port (by which it is connected to the master node) is “active”.

The Deputy state 114 indicates that the forwarding condition of the slave node is “active” and the forwarding condition of its port (by which the slave node is connected to the deputy node) is “active”.

The slave node may activate its port on which it receives a message, wherein said message indicates that its peer port is in an “active” forwarding condition.

The slave node may deactivate a port when it detects a fault condition or when it receives an information indicating a change in the network. For example, when the deputy node is in an “active” forwarding condition and the master node has just recovered and wants to take over its master role again, the slave node receives information via its first port and its second port, indicating that both the deputy node and the master nodes are in the “active” forwarding condition. In this case, the slave node may change a forwarding condition of one of its ports (the one connected to the deputy node) to “standby”.

Columns of the table show a local state information 120, forwarding conditions 121 of the port connected to the master node and forwarding condition 122 of the port connected to the deputy node via the first and the second ports of the slave node, and forwarding conditions 124 of the slave node.

The table also shows forwarding conditions 127 of the master node that is connected to the first port of the slave node and forwarding conditions 126 of the port of the master node that is connected to the first port of the slave node. These forwarding conditions 126, 127 are the conditioned received on the port indicating status information of the master node.

The table of FIG. 14 also shows forwarding conditions 131 of the deputy node that is connected to the second port of the slave node and forwarding conditions 130 of the port of the deputy node that is connected to the second port of the slave node. These forwarding conditions 130, 131 are the conditioned received on the port indicating status information of the deputy node.

In addition, table 110 also depicts a new forwarding conditions 135 of the first port and a new forwarding condition 136 of the second port of the slave node, a new forwarding condition 137 of the slave node, and a new local state 138.

FIG. 15 shows an example of a state flow chart 140 of the slave state machine of FIG. 14.

### Packet Structure

A IEEE 802.1ag protocol can be extended as follows: A link-level Continuity Check Message (CCM) may be provided with a new TLV (type/length/value field), which is used to communicate the forwarding conditions of a node and a port per VLAN.

This TLV can be included in the link-level CCM that is generated by the ports, which are controlled by the TFC. Each port may create the TLV according to its state. This TLV may be named “TFC TLV” and it may comprise a type field amounting to “9” (which corresponds to the first available value in table 21-6 of IEEE 802.1ag). The structure of the TFC TLV is: Type=9; Length=1024 and values.

For each VLAN, two bits can be allocated in the TLV to indicate the forwarding conditions of the node and port for this VLAN:
The first bit indicates the node's forwarding condition for the VLAN. A value “0” indicates that the node is in the “standby” forwarding condition and does not forward traffic in the VLAN. The value “1” indicates that the node is in the “active” forwarding condition and is ready to forward traffic in the VLAN.
The second bit indicates the forwarding condition of the port regarding the VLAN. The value “0” indicates that the port is in the “standby” forwarding condition and does not forward traffic in the VLAN. The value “1” indicates that the port is in the “active” forwarding condition and forwards traffic in the VLAN.

The first two bits in the TFC TLV indicate the information relating to VLAN number 1. The next two bits in the TFC TLV indicate the status relating to VLAN number 2, and so on until VID 4096. This structure may be similar to the structure used in IEEE 802.1ak MVRP (Multiple VLAN Registration Protocol). In this case, only two bits are used per VLAN in contrast to the MVRP which uses three bits per VLAN.

In case of untagged traffic, the first two bits may indicate the status of the entire traffic.

FIG. 8 shows a proposed structure for the TFC TLV based on IEEE 802.1ag CCM.

The protocol according to IEEE 802.1ag is used for fault management purposes and it may be used over an interface. When CCM messages are used to detect a fault condition or a failure and trigger protection switching, a transmission rate for CCM messages may be set to 3.3 ms. Thus, the loss of three CCM messages (used to trigger a protection switching event) can be detected within 10.8 ms. Using CCM messages to communicate the forwarding conditions per VLAN between peer ports may thus ensure that a fault condition in an interconnected zone can be promptly detected and a protection switching in less than 50 ms can be achieved.

Hence, a message and/or protocol may have to be defined or an existing message (format) and/or protocol may be adapted accordingly. This could be relevant also when the concept discussed herein is applied to technologies other than the Ethernet. Such a message may preferably provide information with regard to all services required, in particular information regarding the forwarding conditions. It is of advantage if one message can be used for providing information with regard to forwarding conditions of several services, in particular of all services.

It is noted that the mechanism described herein can be used on tunnels between edge nodes. In such case, one message can be used per tunnel to convey the information on several (in particular all) services and this message may be transmitted via the tunnel. A tunnel in this regard can be a virtual connection and it can be considered as a link throughout a protection zone, e.g., via intermediate network elements of a network. This would efficiently allow avoiding a single point of failure at the ingress or at the egress nodes.

### Edge Protection

The approach presented herein in particular relates to a mechanism designed to protect Carrier Ethernet services in an Ethernet protection domain. An Ethernet protection domain may comprise three or four edge nodes with (two or four) connections between the edge nodes. Ethernet services can enter the protection domain via one out of one or one out of two ingress edge nodes, and exit the protection domain via either one out of one or one out of two egress edge nodes. It is noted that multiple Ethernet protection domains may be defined in the same network. An Ethernet service is transmitted over a single connection in an Ethernet protection domain.

FIG. 4 shows an access chain scenario connecting a core network 401. The solution provided may, e.g., be used protecting a Carrier Ethernet service that is conveyed from a node 404 via an access chain 405 towards the core network 401. The access chain 405 may comprise several access networks. To enhance resiliency, the access networks of the access chain 405 are connected to the core network 401 via two core edge nodes 402, 403. The mechanism suggested protects the Carrier Ethernet services in the access chain 405 by providing separate paths through the access chain 405, which may be independently utilized. In the event of failure in an access network along the path (chain) to one of the core edge nodes 402, 403, traffic can be switched over to the respective other path connecting the node 404 with the core network 401 via the respective other core edge node 403, 402.

FIG. 5 shows another example for providing protection of Carrier Ethernet services within an Ethernet core network 501. The core network 501 is connected to an access network 502 via nodes 504, 505; also, the core network 501 is connected to an access network 503 via nodes 506, 507. The core network 501 may comprise several intermediate nodes (i.e., nodes that are not at the edge of the core network 501) that can be utilized for conveying traffic trough the core network 501. In particular, different paths can be used via said intermediate nodes to convey traffic through the core network 501.

Carrier Ethernet services may enter the Ethernet core network 501 via one out of one or one out of two ingress core edge nodes (i.e. said nodes 504, 505), and exit the Ethernet core network 501 via one out of one or one out of two egress core edge nodes (i.e. said nodes 506, 507).

Advantageously, the approach provided herewith allows protection via several nodes. In other words, not only a direct link is protected by this solution. Hence, protection may apply across at least one network, e.g., a core network, connecting two networks (e.g., access networks) as shown in FIG. 5.

The approach presented in particular applies to a protection between edges (nodes) of a domain to be protected. Such protection domain can be a network, in particular a core network.

It is described above as how direct connectivity between edges of the interconnected zone is provided. However, the mechanism described herein enables protection of Carrier Ethernet services in an Ethernet protection domain where its edge nodes are indirectly connected via several intermediate network elements (e.g., nodes) of the network. Such network may in particular be a core network connected to at least one access network. The connections between the edge nodes of the protection domain thus span multiple hops (nodes and/or links).

The mechanism suggested protects Ethernet services in an Ethernet protection domain comprising three or four edge devices that are (indirectly) connected using at least one of the following connectivity scheme:
(1) “1×2 attached”: The protection domain comprises three edge nodes; one of the edge nodes is indirectly connected to two edge nodes. For a particular set of VLANs, only one of the two connections may be used (at any single time) to forward traffic.
(2) “2×2 attached”: The protection domain comprises four edge nodes. Each node in a pair of edge nodes is indirectly connected to the other two edge nodes. For a particular set of VLANs, only one of the nodes and only one of the two interfaces belonging to that node may be used (at any single time) to forward traffic.

FIG. 6 depicts a core network 604 comprising edge nodes 601, 602 and 603, wherein the node 601 is connected via nodes 605 to 607 with node 602 and via nodes 608 to 610 with node 603. The node 601 is a master node, the nodes 602 and 603 are slave nodes.

Hence, the scenario shown in FIG. 6 corresponds to a “1×2 attached” (indirect) connectivity scheme between three edge nodes 601, 602, 603 in an Ethernet protection domain. The protection domain may be built of access chains that connect one node 601 to two nodes 602, 603. Ethernet services may be transmitted over one of the two connections between the edge nodes of the protection domain.

Also, the role of the edge nodes shown in FIG. 6 may change. For example, node 601 may be a slave node, node 602 may be a master node and node 603 may be a deputy node. In such scenario, the master node can be protected by the deputy node taking over the master node's role in case of a fault condition.

FIG. 7 shows an example of the “2×2 attached” (indirect) connectivity construction, in which the Ethernet protection domain comprises four edge nodes.

The core network 701 comprises a master node 702, a deputy node 703 and two slave nodes 704, 705, wherein these nodes 702 to 705 are edge nodes of the core network 701. In addition, the core network 701 comprises several intermediate nodes 706 to 717.

According to the example of FIG. 7, the master node 702 is connected via nodes 706, 707, 708 to the slave node 704 and via nodes 709, 710, 711 to the slave node 705. The deputy node 703 is connected via nodes 712, 713, 714 to the slave node 704 and via nodes 715, 716, 717 to the slave node 705.

Hence, each of the two nodes on either side of the protection domain is indirectly connected to two edge nodes on the other side of the protection domain. For a particular set of VLANs, only one of the four paths can be used at any single time to forward traffic.

The role of each edge node (master, deputy or slave) in the Ethernet protection domain can be set by administrative configuration for each VLAN. The functionality of the master, deputy and slave nodes is the same as described in the scenarios above and uses the same state machines. The protection mechanism can be utilized per VLAN, independently of any other VLANs. The mechanism works for each VLAN in the Ethernet protection domain.

A protected VLAN may be configured on one or two ports on each of the (three or four) edge nodes of the Ethernet protection domain. Ethernet traffic in a specific VLAN may only be transmitted over one of the (two or four) connections in the Ethernet protection domain. Thus, for example, end-to-end broadcast traffic will not be flooded in the domain, but can be transmitted only once over the Ethernet protection domain.

At any point in time, each node in an Ethernet protection domain may decide which of the ports should be used for carrying traffic. This decision can be made based at least on one of the following information:
The role of the node for that VLAN (i.e. master, deputy or slave).
The role of the port for that VLAN in case the port belongs to a master node or a deputy node. The role of the port may be “working” or “protection”. An additional information is whether the VLAN is operating in revertive or in non-revertive mode.
The current forwarding condition of the node for that VLAN.
The current forwarding condition of the port for that VLAN.
The forwarding conditions of the peer nodes and ports in the Ethernet protection domain; such forwarding condition may be received via the connections to the peer nodes.

This approach utilizes the VLAN level OAM CCM messages to transmit information on the protection states relating to all VLANs that may be transmitted on the path link. The TFC TLV structure can be the same as in the direct connection. However, the VLAN TFC TLV may send the status of the VLANs defined on the MA of that VLAN and it may be extended in order to meet the requirement set forth by the indirect nature of the connectivity between the edge nodes.

Advantageously, the information regarding the protection states of all VLANs is aggregated (as far as possible), so that it may be transmitted over one of the (two or four) connections in the Ethernet protection domain. The node and port forwarding conditions of all protected VLANs may be sent by all ports. Thus, the information may be delivered by means of a single OAM message over a particular connection, e.g., over all the connections.

Thus, an Ethernet Maintenance Association (MA) can be defined per Ethernet protection domain. A service-down Maintenance End Point (MEP) can be defined on each of the three or four edge nodes of the Ethernet protection domain (depending on the connectivity scheme as illustrated above: “1×2 attached” or “2×2 attached”).

A primary VLAN ID (VID) of each MEP in the MA can be one of the VLANs protected in the Ethernet protection domain. OAM messages used by this mechanism can be implemented as service CCMs. The service CCMs are sent between the MEPs and they represent the set of VLANs that are associated with the MA. The service CCMs may be transmitted over the connection between the MEPs (i.e. over the MA).

The TFC TLV structure is similar to the TFC TLV defined above (according to FIG. 8) and comprises the following variation: The first two bits in the TLV represent the node and port forwarding conditions of the Primary VLAN. The next two bits represent the node and port forwarding conditions of the first VLAN in the MA VLAN list. The following two bits represent the forwarding conditions of the next VLAN in the MA VLAN list, and so on.

Hence, the number of bits used is proportional to the number of VLANs that may be transmitted over the Ethernet protection domain (i.e. 2 bits per VID that represent the VLAN). FIG. 9 illustrates the proposed TFC TLV format.

For example, an MA may be associated with a primary VID of 15 and additional VIDs: 3, 30, 300, 301 and 1234. The first 2 bits after the length octet indicate the node and the port forwarding conditions of VLAN 15. The third and fourth bits indicate the node and port forwarding conditions of VLAN 3. The fifth and sixth bits indicate the node and port forwarding conditions of VLAN 30. The seventh and eighth bits indicate the node and port forwarding conditions of VLAN 300, etc. Bits 11 and 12, which are the last bits in the TLV, indicate the node and port forwarding conditions of VLAN 1234 which is the last VLAN in the MA VLAN list.

### Further Advantages

This solution provides a fast recovery mechanism (in particular within less than 50 ms) protecting any type of Carrier Ethernet service against a fault condition or failure or degradation in an Ethernet protection domain.

It is noted that the approach described may apply to other scenarios as Carrier Ethernet as well.

Advantageously, Ethernet services can be protected, which enter a protection domain through either one out of one or one out of two ingress edge nodes and exit the protection domain through either one out of one or one out of two egress edge nodes.

The mechanism defined herein does not require additional connectivity or a communication channel between the pair of edge nodes on each side of the protection domain.

### LIST OF ABBREVIATIONS

### ATM Asynchronous Transfer Mode

### B-VLAN Backbone VLAN

### CCM Continuity Check Message

### C-VLAN Customer LAN

### E-LAN Ethernet LAN

### E-Line Ethernet Line

### EPL Ethernet Private Line

### EP-LAN Ethernet Private LAN

### EP-Tree Ethernet Private Tree

### ETH Ethernet

### E-Tree Ethernet Tree

### ETY Ethernet Physical Layer

### EVPL Ethernet Virtual Private Line

### EVP-LAN Ethernet Virtual Private LAN

### EVP-Tree Ethernet Virtual Private Tree

### FDB Filtering Data Base

### FR Frame Relay

### GFP Generic Framing Procedure

### IEEE Institute of Electrical and Electronics Engineers

### IETF Internet Engineering Task Force

### LAN Local Area Network

### MA Maintenance Association

### MAC Media Access Control

### MEF Metro Ethernet Forum

### MEP Maintenance End Point

### MPLS Multiprotocol Label Switching

### MPLS-TP MPLS-Transport Profile

### MVRP Multiple VLAN Registration Protocol

### OAM Operation Administration Maintenance

### SLA Service Level Agreement

### S-VLAN Service VLAN

### TFC Traffic Forwarding Controller

### TLV Type/Length/Value

### VID VLAN ID

### VLAN Virtual LAN

### VPLS Virtual Private LAN Service

WDM Wavelength Division Multiplexing

1-17. (canceled)

18. A method for conveying traffic in a network, the network containing at least one intermediate network element and a master node connected via the at least one intermediate network element to a slave node, a deputy node is connected via the at least one intermediate network element to the slave node, which comprises the steps of:
conveying traffic between the master node and the slave node; and
conveying the traffic between the deputy node and the slave node in case of a fault condition.

19. A method for conveying traffic in a network, the network having at least one intermediate network element and a master node connected via the at least one intermediate network element to a first slave node and to a second slave node, a deputy node is connected via the at least one intermediate network element to the first slave node and to the second slave node, which comprises the steps of:
conveying traffic between the master node and the first slave node;
performing one of the following in case of a fault condition:
conveying the traffic between the master node and the second slave node; or
conveying the traffic between the deputy node and the first slave node or between the deputy node and the second slave node.

20. The method according to claim 19, which further comprises providing the master node and the deputy node each with two interfaces, wherein each interface is connected to one of the first and second slave nodes.

21. The method according to claim 19, which further comprises connecting the master node via different paths to the first and second slave nodes.

22. The method according to claim 19, which further comprises connecting the deputy node via different paths to the slave nodes.

23. The method according to claim 21, wherein each path leads via intermediate network elements of the network.

24. The method according to claim 19, which further comprises:
connecting the master node via a first interface via the at least one intermediate network element to the first slave node and via a second interface via the at least one intermediate network element to the second slave node;
connecting the deputy node via a further first interface via the at least one intermediate network element to the first slave node and via a further second interface via the at least one intermediate network element to the second slave node; and
performing one of the following steps in case of the fault condition:
switching the master node over from the first interface to the second interface; or
switching the deputy node over from the further first interface to the further second interface.

25. The method according to claim 18, which further comprises again conveying the traffic conveyed between the master node and the slave node after the fault condition is over.

26. The method according to claim 18, wherein the master node, the deputy node and the slave node are network elements at an edge of the network.

27. The method according claim 18, wherein the fault condition comprises or is based on any failure or degradation of an interface or node of the network and comprises at least one of the following:
a link failure;
an interface failure;
a remote interface failure;
a remote node failure;
an administrative operation; and
a node, a link or a port along a path between the deputy node or the master node and the slave node.

28. The method according to claim 18, which further comprises conveying the traffic via a virtual local area network.

29. The method according to claim 18, which further comprises conveying each portion of the traffic via a separate virtual local area network.

30. The method according to claim 18, wherein the traffic is an Ethernet traffic including containing Ethernet frames.

31. The method according to claim 18, which further comprises determining the fault condition via the master node, the deputy node or the slave node.

32. A device, comprising:
at least one controller selected from the group consisting of a processor unit, a hard-wired circuit and a logic device programmed to perform a method for conveying traffic in a network, the network containing at least one intermediate network element and a master node connected via the at least one intermediate network element to a slave node, a deputy node is connected via the at least one intermediate network element to the slave node, the method comprises the steps of:
conveying traffic between the master node and the slave node; and
conveying the traffic between the deputy node and the slave node in case of a fault condition.

33. The device according to claim 32, wherein the device is a communication device.

34. The device according to claim 32, wherein the device is a network element associated with the network or an edge node of the network.

35. A communication system, comprising:
at least one controller selected from the group consisting of a processor unit, a hard-wired circuit and a logic device programmed to perform a method for conveying traffic in a network, the network containing at least one intermediate network element and a master node connected via the at least one intermediate network element to a slave node, a deputy node is connected via the at least one intermediate network element to the slave node, the method comprises the steps of:
conveying traffic between the master node and the slave node; and
conveying the traffic between the deputy node and the slave node in case of a fault condition.

36. A network, comprising:
a master node;
a slave node;
a deputy node;
at least one intermediate network element, said master node connected via said at least one intermediate network element to said slave node, said deputy node connected via said at least one intermediate network element to said slave node; and
the network programmed to convey traffic between said master node and said slave node, and the traffic being conveying between said deputy node and said slave node in case of a fault condition.

37. A network, comprising:
a master node;
a first slave node;
a second slave node;
a deputy node;
at least one intermediate network element, said master node connected via said at least one intermediate network element to said first slave node and to said second slave node, said deputy node connected via said at least one intermediate network element to said slave node and to said second slave node;
the network programmed to convey traffic between said master node and said first slave node, and in case of a fault condition convey the traffic between said master node and said second slave node or convey the traffic between said deputy node and said first slave node or between said deputy node and said second slave node.
